(19) United States
(12) Patent Application Publication
(10) Pub. No.: US 2026/0296224 A1
(43) Pub. Date: Oct. 1, 2026

(54) FUEL CELL VEHICLE

(71) Applicant: HONDA MOTOR CO., LTD., TOKYO (JP)

(72) Inventor: Takuya KANDA, WAKO-SHI (JP)

(21) Appl. No.: 19/576,550

(22) Filed: Mar. 24, 2026

(30) Foreign Application Priority Data
Mar. 26, 2025 (JP) 2025-051472

(51) Int. Cl. B60L 50/71; B60K 1/04

(52) U.S. Cl. CPC B60L 50/71; B60K 1/04; B60K 2001/0405

(57) ABSTRACT

A fixing structure of a fuel cell vehicle includes a support frame to which a fuel cell module is fixed, and a plurality of connecting portions. The connecting portions are mounted to a support frame and are fastened to fastening portions of a pair of side frames. The connecting portions are selected from a plurality of sizes according to the inter-frame distance between the first side frame and the second side frame in the vehicle width direction and are mounted to the support frame.

### CROSS-REFERENCE TO RELATED APPLICATIONS

This application is based upon and claims the benefit of priority from Japanese Patent Application No. 2025-051472 filed on Mar. 26, 2025, the contents of which are incorporated herein by reference.

### BACKGROUND OF THE INVENTION

### Field of the Invention

The present disclosure relates to a fuel cell vehicle.

### Description of the Related Art

JP 2005-231549 A discloses a fuel cell vehicle in which a fuel cell system is mounted. A fuel cell vehicle is provided with a fuel cell module and a mounting member, which is mounted to a side of the fuel cell module. The fuel cell module is fixed to a pair of side frames of a vehicle body frame via the mounting member.

### SUMMARY OF THE INVENTION

A separation distance (inter-frame distance) between a pair of side frames in the vehicle width direction differs for each type of vehicle. Therefore, it is desired that the fuel cell module can be effectively fixed to the pair of side frames in accordance with the inter-frame distance.

The present disclosure aims to solve the aforementioned problems.

An aspect of the present disclosure is a fuel cell vehicle including a vehicle body frame including a pair of side frames facing each other in the vehicle width direction, a fuel cell module, and a fixing structure configured to fix the fuel cell module to the pair of side frames, wherein the fixing structure includes a support frame to which the fuel cell module is fixed, and a plurality of connecting portions mounted to the support frame and fastened to fastening portions of the pair of side frames, the plurality of connecting portions are selected from a plurality of sizes according to the inter-frame distance that is the distance between the pair of side frames in the vehicle width direction, and are mounted to the support frame.

According to the present disclosure, the fuel cell module can be effectively fixed to the first side frame and the second side frame by using the connecting portion selected according to the inter-frame distance between the first side frame and the second side frame in the vehicle width direction.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic plan view of a fuel cell vehicle according to an embodiment of the present disclosure;

FIG. 2 is an enlarged plan view of the fuel cell vehicle shown in FIG. 1;

FIG. 3 is a cross-sectional view taken along line III-III of FIG. 2;

FIG. 4 is a cross-sectional view taken along line IV-IV of FIG. 1; and

FIG. 5 is an explanatory diagram for a case where a fuel cell module is mounted on a fuel cell vehicle whose inter-frame distance is different from that of the fuel cell vehicle shown in FIG. 3.

### DETAILED DESCRIPTION OF THE INVENTION

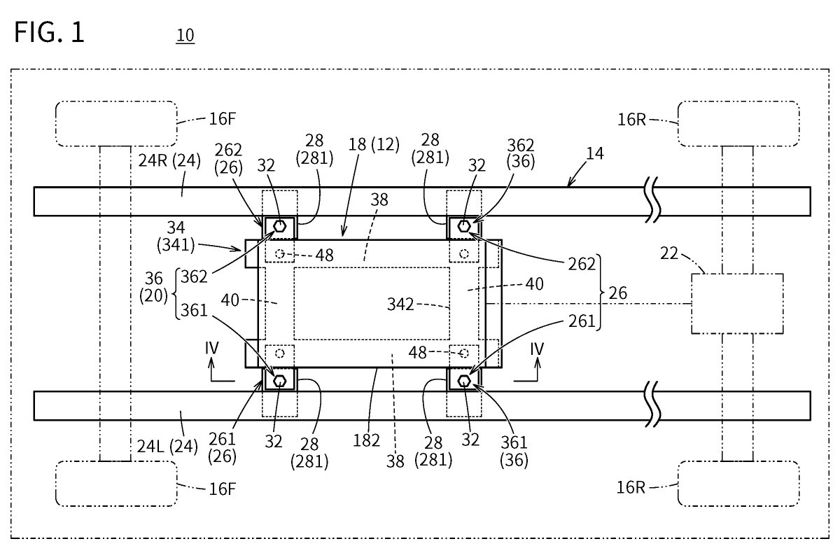

As shown in FIG. 1, a fuel cell vehicle 10 according to the present embodiment is equipped with a fuel cell system 12. The fuel cell vehicle 10 includes a vehicle body frame 14, front wheels 16F, rear wheels 16R, a cell module 18, a fixing structure 20, and a motor 22. The motor 22 is operated by power supplied from the fuel cell module 18 and drives at least the front wheels 16F or the rear wheels 16R. The motor 22 is fixed to, for example, the vehicle body frame 14.

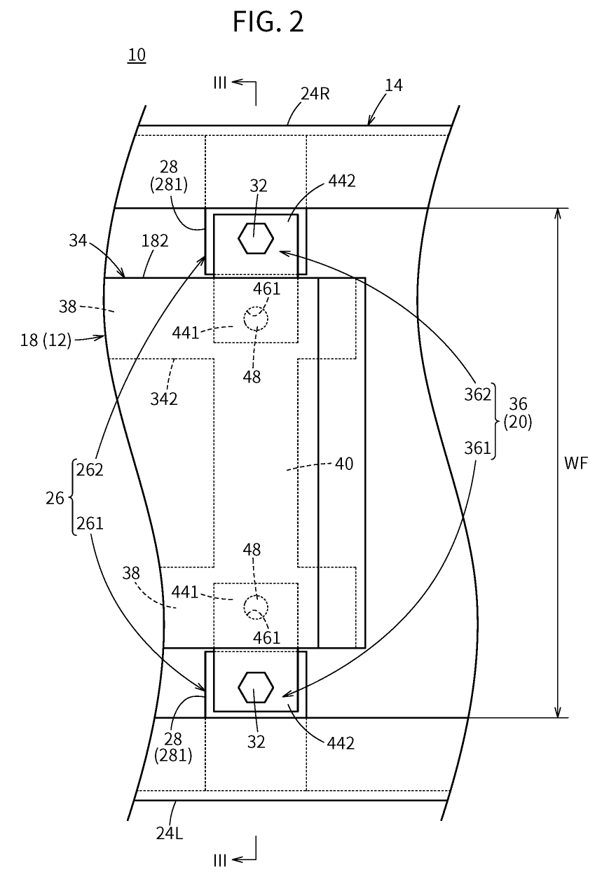

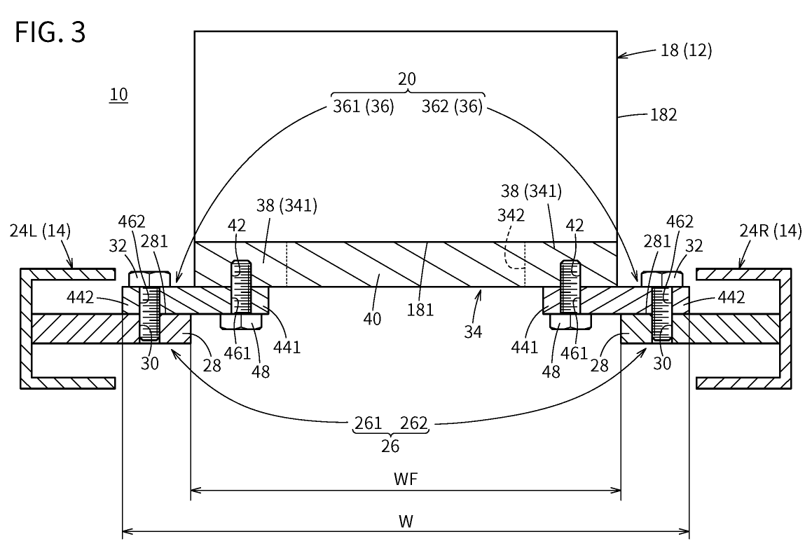

The vehicle body frame 14 is provided with a pair of side frames 24. The pair of side frames 24 will be referred to as a first side frame 24L and a second side frame 24R. Each of the first side frame 24L and the second side frame 24R extends along the vehicle front-rear direction (hereinafter referred to as the “front-rear direction") of the fuel cell vehicle 10 (hereinafter also referred to as the vehicle 10). The first side frame 24L and the second side frame 24R face each other in the vehicle width direction of the vehicle 10. The first side frame 24L and the second side frame 24R are provided in parallel with each other with a predetermined width (hereinafter referred to as "inter-frame distance WF") apart in the vehicle width direction (see FIG. 2). As shown in FIG. 3, when viewed from the front-rear direction of the vehicle 10, each of the first side frame 24L and the second side frame 24R is formed in a U-shaped cross-section that opens inward in the vehicle width direction (see FIG. 3).

As shown in FIG. 1, each of the first side frame 24L and the second side frame 24R includes a plurality of fastening portions 26. The fixing structure 20 is fixed to each fastening portion 26. The plurality of fastening portions 26 are provided on the first side frame 24L and the second side frame 24R. As shown in FIG. 2, each fastening portion 26 includes a projecting portion 28. As shown in FIG. 3, the projecting portion 28 projects inward in the vehicle width direction from the respective inner end portions of the first side frame 24L and the second side frame 24R. Each projecting portion 28 is provided horizontally along the vehicle width direction.

As shown in FIG. 1, the fastening portion 26 provided on the first side frame 24L is referred to as a "first fastening portion 261" whereas the fastening portion 26 provided on the second side frame 24R is referred to as a "second fastening portion 262". The first fastening portion 261 of the first side frame 24L and the second fastening portion 262 of the second side frame 24R face each other in the vehicle width direction. A case will be described in which the first side frame 24L and the second side frame 24R are respectively provided with two first fastening portions 261 and two second fastening portions 262.

As shown in FIG. 3, each projecting portion 28 of the first fastening portion 261 and the second fastening portion 262 is provided with a fastening hole 30. Each of the fastening holes 30 penetrates in the up-down direction, into which the fastening bolt 32 is fastened.

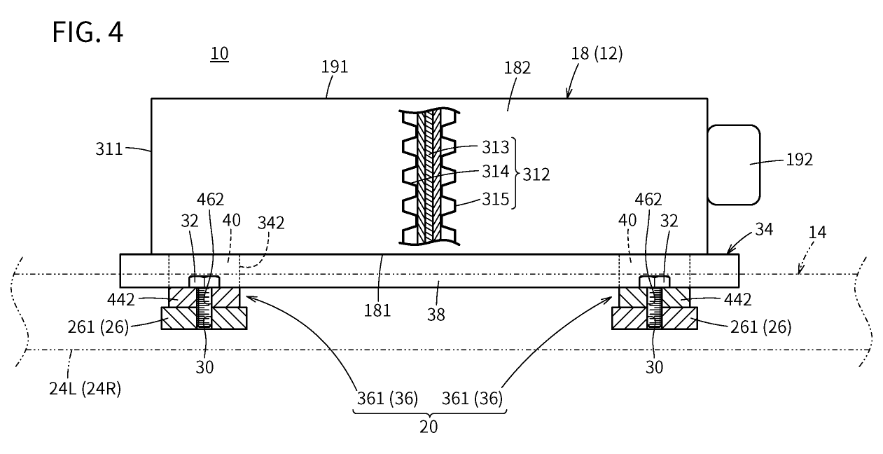

The fuel cell module 18 is fixed to the first side frame 24L and the second side frame 24R by the fixing structure 20. As shown in FIG. 4, the fuel cell module 18 includes a fuel cell stack 191 and a plurality of auxiliary devices 192 for driving the fuel cell stack 191. The fuel cell stack 191 has a stack case 311 and a plurality of power generating cells 312. The stack case 311 accommodates a plurality of power generating cells 312.

The plurality of power generating cells 312 generates power through an electrochemical reaction between an anode gas (fuel gas such as hydrogen) supplied from an anode system device and a cathode gas (oxygen containing gas such as air) supplied from a cathode system device. Each power generating cell 312 is composed of a membrane electrode assembly 313 and two separators 314, 315 sandwiching the membrane electrode assembly 313. The plurality of power generating cells 312 are stacked in the front-rear direction of the vehicle 10 with electrode surfaces in a standing posture. The upper surface of the fuel cell stack 191 is located at a higher position than the first side frame 24L and the second side frame 24R.

As shown in FIG. 1, the fixing structure 20 includes a support frame 34 and a plurality of connecting portions 36.

The fuel cell module 18 is fixed to the support frame 34. The support frame 34 is provided at a lower part of the fuel cell module 18. The support frame 34 supports a bottom portion 181 of the fuel cell module 18 (see FIG. 3).

The support frame 34 is a frame-like member provided with a frame outer edge portion 341 and an opening portion 342. The configuration is not limited to a case where the support frame 34 is formed in a frame shape. The configuration is not limited to a case where the support frame 34 includes the frame outer edge portion 341 and the opening portion 342. For example, the support frame 34 may be a plate-like member without an opening portion.

The frame outer edge portion 341 is provided along an outer peripheral portion 182 of the fuel cell module 18 in a plan view. The outer shape of the frame outer edge portion 341 is rectangular. The frame outer edge portion 341 includes a pair of side portions 38 and a pair of coupling portions 40. The pair of side portions 38 are spaced apart from each other in the vehicle width direction and extend in the front-rear direction of the vehicle 10. The pair of side portions 38 face the first side frame 24L and the second side frame 24R. In a plan view, each side portion 38 of the support frame 34 and the fuel cell module 18 overlap.

As shown in FIG. 3, a lower surface of each side portion 38 includes a plurality of coupling holes 42. Each coupling hole 42 is formed upward from the lower surface of the side portion 38. The number of the coupling holes 42 is the same as the number of the connecting portions 36.

As shown in FIG. 1, each of the pair of coupling portions 40 extends in the vehicle width direction. One coupling portion 40 connects front end portions of the pair of side portions 38 to each other. The other coupling portion 40 connects rear end portions of the pair of side portions 38 to each other.

The opening portion 342 is surrounded by the frame outer edge portion 341. The opening portion 342 penetrates in the up-down direction of the support frame 34 (see FIG. 3).

As shown in FIG. 3, the plurality of connecting portions 36 are mounted to the frame outer edge portion 341 of the support frame 34. The plurality of connecting portions 36 are fastened to the fastening portions 26 of the first side frame 24L and the second side frame 24R, respectively.

The plurality of connecting portions 36 are selected from a plurality of sizes according to the inter-frame distance WF between the first side frame 24L and the second side frame 24R and are mounted to the support frame 34.

The plurality of connecting portions 36 are provided at the support frame 34 in the vehicle width direction of the vehicle 10, respectively. As shown in FIG. 1, the plurality of connecting portions 36 includes two or more connecting portions 36 provided along the front-rear direction of the vehicle 10. The following description is made on a case where the first side frame 24L and the second side frame 24R are respectively provided with the two connecting portions 36. The configuration is not limited to a case where two connecting portions 36 are provided at each of the pair of side frames 24. For example, three or more connecting portions 36 may be provided at each of the pair of side frames 24. It is preferable that the number of the connecting portions 36 at the first side frame 24L is the same as the number of the connecting portions 36 at the second side frame 24R.

As shown in FIG. 2, each connecting portion 36 includes a first end portion 441 and a second end portion 442.

The first end portion 441 is coupled to the side portion 38 of the support frame 34. The second end portion 442 is positioned further outward in the vehicle width direction than the first end portion 441. The second end portion 442 is fastened to each of the first fastening portion 261 (projecting portion 28) of the first side frame 24L and the second fastening portion 262 (projecting portion 28) of the second side frame 24R. In a plan view, the first end portion 441 and the side portion 38 of the support frame 34 overlap with each other whereas the second end portion 442 and the projecting portion 28 of the first fastening portion 261 overlap with each other. The first end portion 441 and the side portion 38 of the support frame 34 need not overlap with each other. The second end portion 442 and the projecting portion 28 of the first fastening portion 261 need not overlap each other.

As shown in FIG. 3, the first end portion 441 has a first hole portion 461. The first hole portion 461 penetrates in the up-down direction, into which the connecting bolt 48 is inserted. The second end portion 442 contacts the upper surface 281 of each projecting portion 28. The second end portion 442 has a second hole portion 462. The second hole portion 462 penetrates in the up-down direction, into which the fastening bolt 32 is inserted. The fastening bolt 32 inserted through the second hole portion 462 is fastened into each fastening hole 30 of the first and second fastening portions 261 and 262.

Hereinafter, the connecting portion 36 provided on one side portion 38 in the vehicle width direction is referred to as a "first connecting portion 361" whereas the connecting portion 36 provided on the other side portion 38 in the vehicle width direction is referred to as a "second connecting portion 362". As shown in FIG. 1, the two first connecting portions 361 are fastened to the two first fastening portions 261, respectively. The two second connecting portions 362 are fastened to the two second fastening portions 262, respectively.

Next, a case where the fuel cell module 18 is fixed to the first side frame 24L and the second side frame 24R in the fuel cell vehicle 10 will be described.

First, a connecting portion 36 of a size corresponding to the inter-frame distance WF between the first side frame 24L and the second side frame 24R is selected from a plurality of connecting portions 36 having different sizes and is assembled to the support frame 34. The size of the connecting portion 36 is the length from the first end portion 441 to the second end portion 442 in the extending direction of the connecting portion 36.

The first end portions 441 of the four selected connecting portions 36 are placed at the end portions of the side portions 38 of the support frame 34, and the connecting bolt 48 is inserted from below into each first hole portion 461 and fastened into each coupling hole 42. Thus, the two first connecting portions 361 are connected to the lower portion of one side portion 38 whereas the two second connecting portions 362 are connected to the lower portion of the other side portion 38. Each of the first connecting portion 361 and the second connecting portion 362 is fixed to the side portion 38 in a state of projecting outward in the vehicle width direction. In the vehicle width direction, the width W of the fixing structure 20 is between the second end portion 442 of the first connecting portion 361 and the second end portion 442 of the second connecting portion 362. That is, by mounting the selected first connecting portion 361 and second connecting portion 362 to the support frame 34, the width of the fixing structure 20 can be made to be a width in accordance with the inter-frame distance WF.

Then, the fixing structure 20 is inserted between the first side frame 24L and the second side frame 24R after fixing the bottom portion 181 of the fuel cell module 18 to the support frame 34 to which the plurality of connecting portions 36 are mounted. The first connecting portions 361 and the second connecting portions 362 are held in contact with the upper surfaces 281 of the projecting portions 28 of the fastening portions 26. At this time, in a plan view, the first connecting portion 361 and the second connecting portion 362 overlap the projecting portions 28 (see FIG. 1).

Then, the fastening bolt 32 is inserted into the second hole portion 462 of each first connecting portion 361, the fastening bolt 32 is fastened into the fastening hole 30 of the first fastening portion 261, the fastening bolt 32 is inserted into the second hole portion 462 of each second connecting portion 362, and the fastening bolt 32 is fastened into the fastening hole 30 of the second fastening portion 262.

Thus, the first connecting portion 361 of the fixing structure 20 is fixed to the first fastening portion 261 of the first side frame 24L, and the second connecting portion 362 of the fixing structure 20 is fixed to the second fastening portion 262 of the second side frame 24R. The fuel cell module 18 is fixed to the first side frame 24L and the second side frame 24R of the fuel cell vehicle 10 via the fixing structure 20.

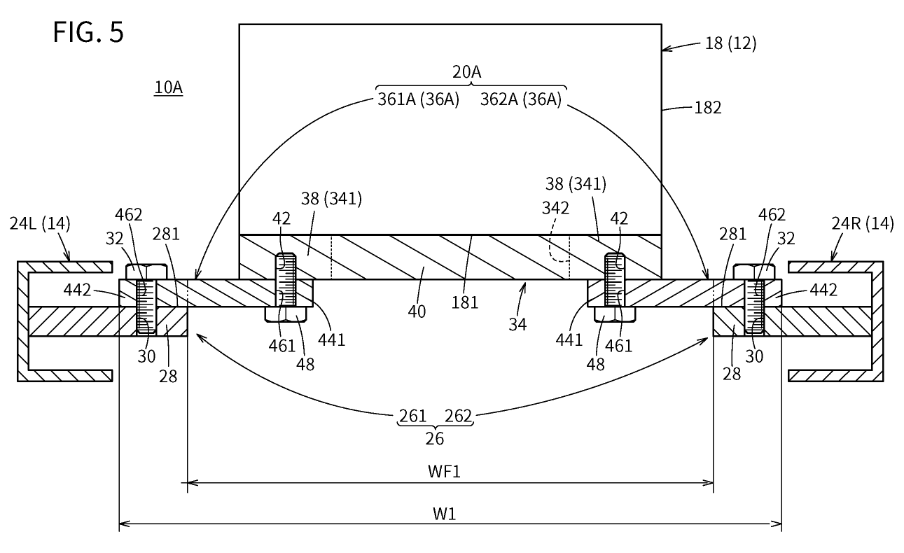

Here, a case will be described with reference to FIG. 5 where the fuel cell module 18 is fixed via a fixing structure 20A to a vehicle 10A having a different inter-frame distance WF between the first side frame 24L and the second side frame 24R. Here, a case will be described where the fixing structure 20A is fixed to the vehicle 10A having a larger inter-frame distance WF1 than the distance between the first side frame 24L and the second side frame 24R of the above-described embodiment.

First, a connecting portion 36A of a size corresponding to the inter-frame distance WF1 between the first side frame 24L and the second side frame 24R is selected from a plurality of connecting portions 36 having different sizes and is assembled to the support frame 34. Compared to the connecting portion 36 of the vehicle 10 having the above-described inter-frame distance WF, the selected connecting portion 36A is larger. By mounting a selected first connecting portion 361A and second connecting portion 362A to the support frame 34, the width W1 of the fixing structure 20A can be set according to the inter-frame distance WF1.

By respectively fastening the first connecting portion 361A and the second connecting portion 362A of the fixing structure 20A to the first fastening portion 261 of the first side frame 24L and the second fastening portion 262 of the second side frame 24R, the fuel cell module 18 can be fixed by the fixing structure 20A to the first side frame 24L and the second side frame 24R separated from each other by the inter-frame distance WF1.

The present embodiment provides the following benefits.

As shown in FIG. 3, the fixing structure 20 of the fuel cell vehicle 10 includes a support frame 34 to which the fuel cell module 18 is fixed, and a plurality of connecting portions 36 mounted to the support frame 34 and fastened to the fastening portions 26 of the pair of side frames 24. The plurality of connecting portions 36 are selected from a plurality of sizes according to the inter-frame distance WF between the first side frame 24L and the second side frame 24R and are mounted to the support frame 34.

According to this fuel cell vehicle 10, the fuel cell module 18 can be effectively fixed to the first side frame 24L and the second side frame 24R by using the connecting portion 36 selected according to the separation distance (inter-frame distance WF) between the first side frame 24L and the second side frame 24R in the vehicle width direction.

As shown in FIG. 2, each of the plurality of fastening portions 26 has a projecting portion 28 that projects inward in the vehicle width direction from each of the first side frame 24L and the second side frame 24R. In a plan view, the plurality of connecting portions 36 overlap the plurality of projecting portions 28, and the plurality of connecting portions 36 contact and are fastened to the upper surfaces 281 of the plurality of projecting portions 28, respectively.

According to this configuration, the fuel cell module 18 can be effectively fixed by the plurality of connecting portions 36 in a state in which the fuel cell module 18 is mounted on each of the first side frame 24L and the second side frame 24R.

As shown in FIG. 1, the support frame 34 has the frame outer edge portion 341 provided along the outer periphery portion 182 of the fuel cell module 18 in a plan view, and the opening portion 342 surrounded by the frame outer edge portion 341. The connecting portion 36 is provided at the frame outer edge portion 341.

According to this structure, the support frame 34 can be effectively light-weighted by providing the opening portion 342, and the support frame 34 can be firmly fastened to the pair of side frames 24 by the connecting portions 36 provided at the outer peripheral portion 182.

The plurality of connecting portions 36 are provided in the vehicle width direction of the vehicle 10. According to this configuration, the fuel cell module 18 can be more effectively fixed to the pair of side frames 24 by the connecting portions 36 provided on both sides in the vehicle width direction.

The plurality of connecting portions 36 includes two or more connecting portions 36 provided along the front-rear direction of the vehicle 10. According to this configuration, the fuel cell module 18 can be effectively fixed to the first side frame 24L and the second side frame 24R by the plurality of connecting portions 36.

As shown in FIG. 2, each of the plurality of connecting portions 36 includes the first end portion 441 connected to the support frame 34 and the second end portion 442 arranged further outward in the vehicle width direction than the first end portion 441 and fastened to the fastening portion 26. In a plan view, the first end portion 441 and the support frame 34 overlap each other, and the second end portion 442 and the projecting portion 28 overlap each other.

According to this configuration, the fixing structure 20 can be efficiently fixed to the first side frame 24L and the second side frame 24R by selectively mounting the connecting portion 36 having a length overlapping the support frame 34 and the fastening portion 26 to the first side frame 24L and the second side frame 24R having different inter-frame distances WF.

With respect to the above disclosure, the following supplementary notes are further disclosed.

### Supplementary Note 1

A fuel cell vehicle (10) includes a vehicle body frame (14) including a pair of side frames (24L, 24R) facing each other in the vehicle width direction, a fuel cell module (18), and a fixing structure (20) configured to fix the fuel cell module to the pair of side frames, wherein the fixing structure includes a support frame (34) to which the fuel cell module is fixed, and a plurality of connecting portions (36) mounted to the support frame and fastened to fastening portions (26) of the pair of side frames, the plurality of connecting portions are selected from a plurality of sizes according to the inter-frame distance (WF) that is the distance between the pair of side frames in the vehicle width direction, and are mounted to the support frame.

According to such a fuel cell vehicle, the fuel cell module can be effectively fixed to the first side frame and the second side frame by using the connecting portion selected according to the separation distance between the first side frame and the second side frame in the vehicle width direction.

### Supplementary note 2

In the fuel cell vehicle described in Supplementary note 1, at least one of the fastening portions may be provided at each of the pair of the side frames, each of the fastening portions may include a projecting portion (28) projecting inward in the vehicle width direction from the pair of side frames, and in a plan view, the plurality of the connecting portions may overlap the plurality of the projecting portions, respectively, and the plurality of the connecting portions may contact and be fastened to the upper surfaces (281) of the plurality of the projecting portions, respectively. According to such a configuration, the fuel cell module can be effectively fixed to the pair of side frames by the plurality of connecting portions in a mounted state.

### Supplementary note 3

In the fuel cell vehicle described in Supplementary note 1 or 2, the support frame may include a frame outer edge portion (341) provided along an outer peripheral portion (182) of the fuel cell module in a plan view, and an opening portion (342) surrounded by the frame outer edge portion, and each of the connecting portions may be provided at the frame outer edge portion.

According to such a configuration, the opening portion can effectively reduce the weight of the support frame, and the support frame can be firmly fastened to the pair of side frames by the connecting portion provided at the outer peripheral portion.

### Supplementary note 4

In the fuel cell vehicle of Supplementary note 2, the plurality of connecting portions may be provided on each side in the vehicle width direction of the fuel cell vehicle. According to such a configuration, the fuel cell module can be more effectively fixed to the pair of side frames by the connecting portions provided on both sides in the vehicle width direction.

### Supplementary note 5

In the fuel cell vehicle of Supplementary note 4, the plurality of connecting portions may include two or more connecting portions along the front-rear direction of the fuel cell vehicle. According to such a configuration, the fuel cell module can be effectively fixed to each side frame by the plurality of connecting portions.

### Supplementary note 6

In the fuel cell vehicle described in Supplementary note 2, each of the plurality of connecting portions may include a first end portion (441) connected to the support frame, and a second end portion (442) positioned further outward in the vehicle width direction than the first end portion and fastened to the fastening portion, and in a plan view, the first end portion and the support frame may overlap each other, and the second end portion and the projecting portion may overlap each other.

According to such a configuration, the fixing structure can be efficiently fixed to the pair of side frames by selectively mounting the connecting portion having a length overlapping the support frame and the fastening portion to a pair of side frames having a different inter-frame distance.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A fuel cell vehicle comprising:
a vehicle body frame including a pair of side frames facing each other in a vehicle width direction;
a fuel cell module; and
a fixing structure configured to fix the fuel cell module to the pair of side frames,
wherein
the fixing structure includes
a support frame to which the fuel cell module is fixed, and
a plurality of connecting portions mounted to the support frame and fastened to fastening portions of the pair of side frames,
the plurality of connecting portions are selected from a plurality of sizes according to an inter-frame distance that is a distance between the pair of side frames in the vehicle width direction, and are mounted to the support frame.

2. The fuel cell vehicle according to claim 1,
wherein
at least one of the fastening portions is provided at each of the pair of side frames,
each of the fastening portions includes a projecting portion projecting inward in the vehicle width direction from the pair of side frames,
in a plan view, the plurality of connecting portions overlap the plurality of projecting portions, respectively, and
the plurality of connecting portions contact and are fastened to upper surfaces of the plurality of projecting portions, respectively.

3. The fuel cell vehicle according to claim 1, wherein
the support frame includes
a frame outer edge portion provided along an outer periphery portion of the fuel cell module in a plan view, and
an opening portion surrounded by the frame outer edge portion, and
each of the connecting portions is provided at the frame outer edge portion.

4. The fuel cell vehicle according to claim 2, wherein
the plurality of connecting portions are provided on each side in the vehicle width direction of the fuel cell vehicle.

5. The fuel cell vehicle according to claim 4, wherein
the plurality of connecting portions include two or more connecting portions along a front-rear direction of the fuel cell vehicle.

6. The fuel cell vehicle according to claim 2,
wherein
each of the plurality of connecting portions includes
a first end portion connected to the support frame, and
a second end portion positioned further outward in the vehicle width direction than the first end portion and fastened to the fastening portion, and
in a plan view, the first end portion and the support frame overlap each other, and the second end portion and the projecting portion overlap each other.
